(19) United States
(12) Patent Application Publication
(10) Pub. No.: US 2026/0097709 A1
(43) Pub. Date: Apr. 9, 2026

(54) LADDER ASSEMBLY AND VEHICLE

(71) Applicant: T-MAX (HANGZHOU) TECHNOLOGY CO., LTD., Hangzhou (CN)

(72) Inventors: Yiming WANG, Hangzhou (CN); Hanxin ZHANG, Hangzhou (CN); Songfeng WANG, Hangzhou (CN)

(21) Appl. No.: 19/081,874

(22) Filed: Mar. 17, 2025

(30) Foreign Application Priority Data
Oct. 9, 2024 (CN) 202411408203.4
Oct. 9, 2024 (CN) 202422437549.9

(51) Int. Cl. B60R 3/02

(52) U.S. Cl. CPC B60R 3/02

(57) ABSTRACT

Disclosed is a ladder assembly and a vehicle with a ladder assembly. In some aspects, the ladder assembly includes a mounting frame, a first ladder frame, and a second ladder frame, wherein the first ladder frame is pivotally connected with the mounting frame so that the first ladder frame swings between a stowed position and a deployed position relative to the mounting frame, and the second ladder frame is slidably connected with the first ladder frame so that the second ladder frame moves between an extended position and a retracted position relative to the first ladder frame.

### CROSS-REFERENCE TO RELATED APPLICATIONS

This patent document claims priority to and benefits of Chinese Application No. 202411408203.4 and Chinese Application No. 202422437549.9, each filed on Oct. 9, 2024. The contents of the aforementioned applications are incorporated by reference in their entireties for all purposes.

### TECHNICAL FIELD

This patent document relates to ladders, in particular to a ladder assembly and a vehicle with a ladder assembly.

### BACKGROUND

A ladder is a structure for climbing up or down that includes two long sidepieces joined at intervals by crosspieces on which one may step.

### SUMMARY

The present technology aims at solving technical problems in the related arts of ladders, at least to some extent. Embodiments in accordance with the present technology provide a ladder assembly, which has the advantages of occupying a small space by the ladder frame, having a simple structure, and providing high stability and structural strength with simple and convenient operation and use.

Embodiments in accordance with the present technology also provide a vehicle including the ladder assembly of the above embodiments.

A first aspect of the present technology provides a ladder assembly, including: a mounting frame; a first ladder frame pivotally connected with the mounting frame, so that the first ladder frame is configured to swing between a stowed position and a deployed position relative to the mounting frame; and a second ladder frame slidably connected with the first ladder frame, so that the second ladder frame is configured to move between an extended position and a retracted position relative to the first ladder frame.

A second aspect of the present technology provides a ladder assembly, including: a mounting frame; a first ladder frame pivotally connected with the mounting frame; a second ladder frame extendably and retractably connected with the first ladder frame; a connecting rod having a first connecting-rod end pivotally connected with the mounting frame, and a second connecting-rod end pivotally connected with the first ladder frame; and a locking part for locking the first ladder frame to prevent the first ladder frame from swinging relative to the mounting frame or for releasing the first ladder frame to allow the first ladder frame to swing relative to the mounting frame, wherein the ladder assembly is configured to move between the following states: a stowed state, in which the first ladder frame swings into the mounting frame and is arranged side by side with the mounting frame, and the second ladder frame is retracted relative to the first ladder frame; a deployed state, in which the first ladder frame swings out from the mounting frame and forms a predetermined included angle with the mounting frame; and an extended state, in which the first ladder frame swings out from the mounting frame to form a predetermined included angle with the mounting frame, and the second ladder frame extends out relative to the first ladder frame.

According to the ladder climbing assembly of embodiments of the present technology, the first ladder frame is stowed and deployed relative to the mounting frame by pivoting, and the second ladder frame extends and is retracted relative to the first ladder frame by sliding, so that the ladder climbing assembly is small in volume and occupied space, high in structural strength and stability, simple and convenient to operate and use, and labor-saving.

A third aspect of the present technology provides a ladder assembly, including a mounting frame; a first ladder frame pivotally connected with the mounting frame and configured to swing into or out from the mounting frame; and a second ladder frame including a first portion and a second portion, wherein a lower end of the first portion is pivotally connected with an upper end of the second portion; the second ladder frame is slidably connected with the first ladder frame; and the second ladder frame is extendable relative to the first ladder frame so that the lower end of the first portion and the second portion extend beyond the first ladder frame and the second portion is oriented in a vertical direction, and the second ladder frame is retractable relative to the first ladder frame so that a lower end of the second portion abuts against a lower end of the first ladder frame.

A vehicle of an embodiment in accordance with the present technology includes a vehicle body and a ladder assembly, wherein the ladder assembly is the ladder assembly described in any of the above embodiments, and the ladder assembly is installed on the vehicle body.

The vehicle has the advantages of small volume and occupied space, high structural strength and stability, simple and convenient operation and use, and labor savings, with a low wind resistance of the vehicle body.

### BRIEF DESCRIPTION OF THE DRAWINGS

FIG. 1 is a schematic perspective view of a ladder assembly according to an example embodiment of the present technology, in which a first ladder frame is in a stowed position, a second ladder frame is in a retracted position, and a locking part is in a locked state;

FIG. 2 is a schematic perspective view of the ladder assembly shown in FIG. 1 from another perspective;

FIG. 3 is an exploded schematic view of the ladder assembly according to an example embodiment of the present technology;

FIG. 4 is an exploded schematic view of a mounting frame of the ladder assembly according to an example embodiment of the present technology;

FIG. 5 is an exploded view of a first ladder frame of the ladder assembly according to an example embodiment of the present technology;

FIG. 6 is an exploded schematic view of a second ladder frame of the ladder assembly according to an example embodiment of the present technology;

FIG. 7A is a schematic sectional view of a first fastening part of the ladder assembly according to an example embodiment of the present technology;

FIG. 7B is a schematic sectional view of a second fastening part of the ladder assembly according to an example embodiment of the present technology;

FIG. 8 is an exploded schematic view of a locking part of the ladder assembly according to an example embodiment of the present technology;

FIG. 9 is a partial sectional view of a ladder assembly according to an example embodiment of the present technology, in which a locking part is in a locked state;

FIG. 10 is a partial sectional schematic view of a ladder assembly according to an example embodiment of the present technology, in which the locking part is in a released state;

FIG. 11 is a schematic perspective view of a ladder assembly according to an example embodiment of the present technology, in which the first ladder frame swings from a stowed position to a deployed position, the second ladder frame is in a retracted position, and the locking part is in the released state;

FIG. 12 is a schematic perspective view of a ladder assembly according to an example embodiment of the present technology, in which the first ladder frame is in a deployed position, the second ladder frame is in a retracted position, and the locking part is in a released state;

FIG. 13 is a schematic perspective view of a ladder assembly according to an example embodiment of the present technology, in which the first ladder frame is in a deployed position, the second ladder frame is in a retracted position, and the locking part is in a locked state;

FIG. 14 is a schematic perspective view of a ladder assembly according to an example embodiment of the present technology, in which the first ladder frame is in a deployed position, the second ladder frame is in an extended position, and the locking part is in a locked state, and the lower side beam section of the second ladder frame is generally coaxial with a lower side beam section;

FIG. 15 is a partial schematic view of the ladder assembly shown in FIG. 14;

FIG. 16 is a schematic perspective view of a ladder assembly according to an example embodiment of the present technology, in which the first ladder frame is in a deployed position, the second ladder frame is in an extended position, and the locking part is in a locked state, and the lower side beam section of the second ladder frame swings downward by a predetermined angle relative to a lower side beam section and extends in a generally vertical direction;

FIG. 17 is a schematic side view of the ladder assembly shown in FIG. 16;

FIG. 18 is a partial schematic view of the ladder assembly shown in FIG. 16;

FIG. 19 is another partial schematic view of the ladder assembly shown in FIG. 16;

FIG. 20 is a schematic view of a vehicle according to an example embodiment of the present technology.

### DETAILED DESCRIPTION

Typically, a ladder for a vehicle includes an upper ladder frame and a lower ladder frame, and the upper ladder frame is installed on the vehicle body through a connecting rod, so that the upper ladder frame, the connecting rod and the vehicle body form a four-bar mechanism, thereby resulting in the upper ladder frame being folded onto the vehicle body or protruding outward from the vehicle body. When the ladder is in use, the weight of the human body is mainly borne by the connecting rod, which has the problem of poor structural strength and poor stability, which affects the usability. For a conventional ladder, the upper ladder frame is rotatably connected with the lower ladder frame through a pivot. When the ladder is not in use, the user folds the lower ladder frame over onto the upper ladder frame. When the ladder is in use, the user unfolds the lower ladder frame from the upper ladder frame. The folding and unfolding operations of the lower ladder frame require a large space, and the ladder after folding takes up a large space. The folding and unfolding operations of the lower ladder frame are also laborious, which is inconvenient during use.

Embodiments of a ladder assembly and vehicle in accordance with the present technology will be described in detail and illustrated through the examples in the accompanying drawings. The embodiments described below by referring to the drawings are exemplary and are intended to explain the present technology, but not to be construed as limiting the present technology.

Hereinafter, a ladder assembly according to an embodiment of the present technology will be described with reference to the drawings.

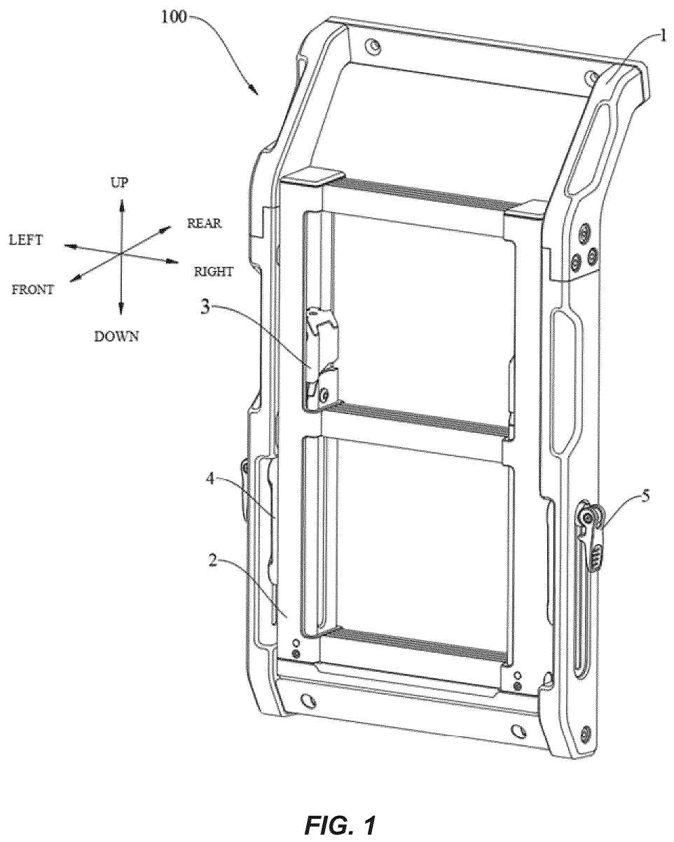

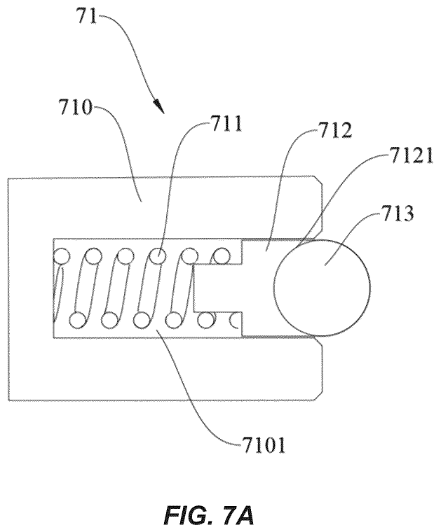

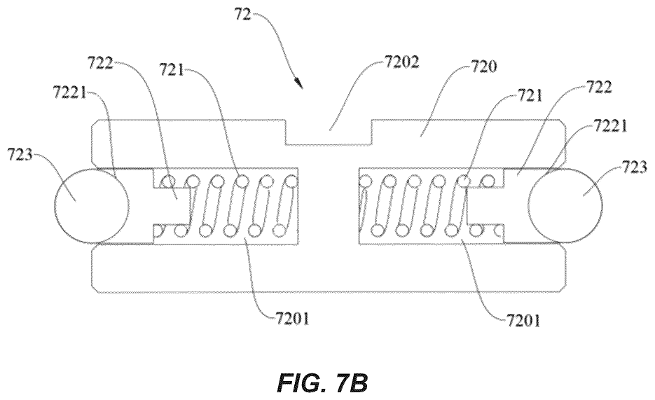

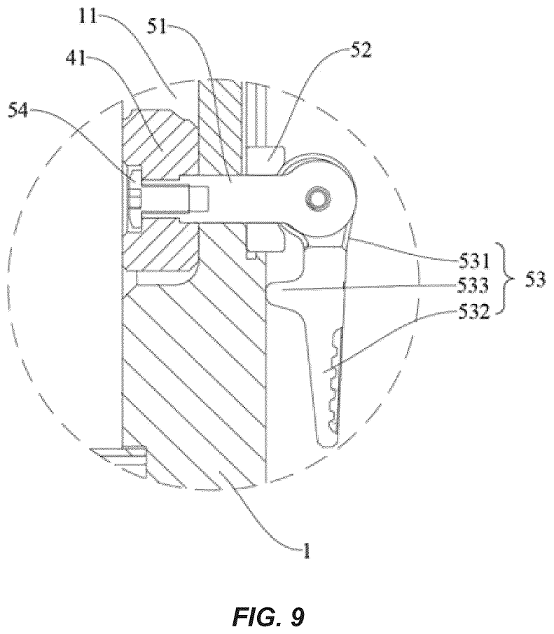

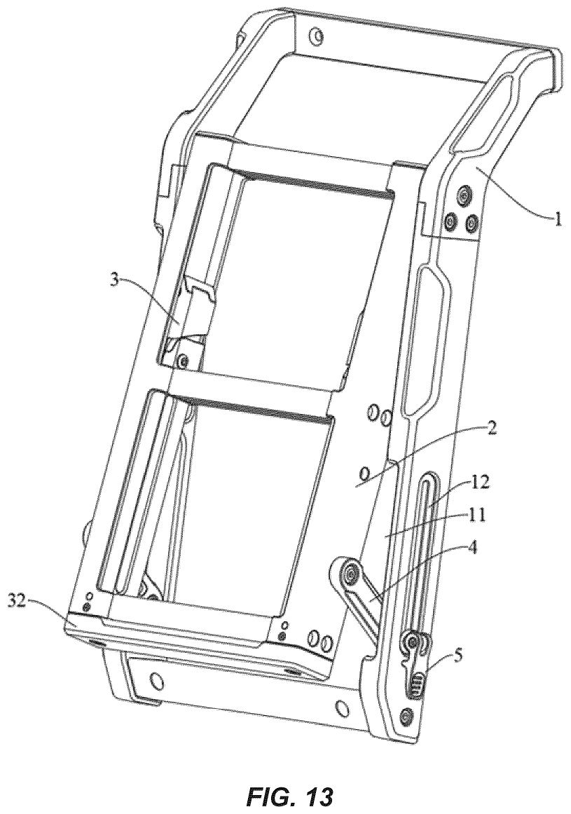

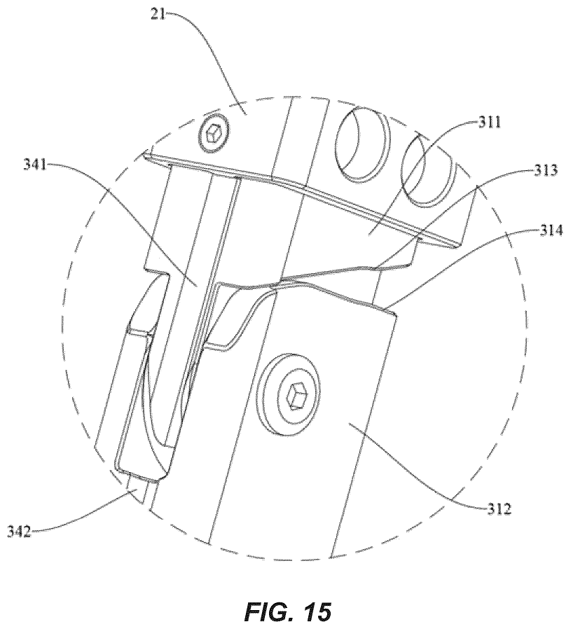

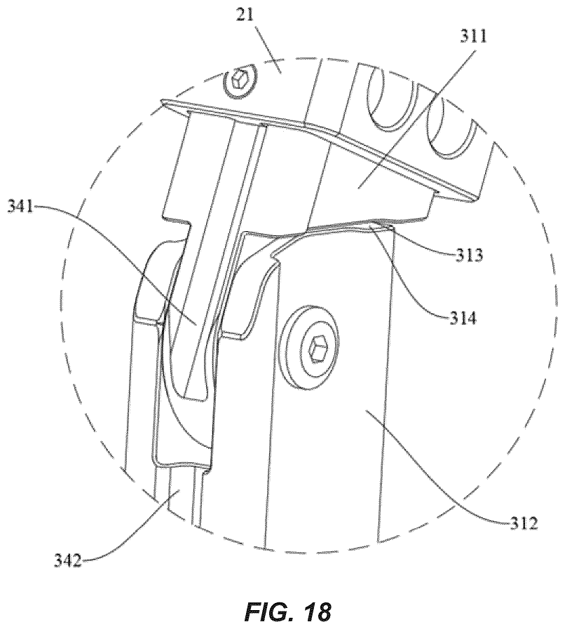

As shown in FIGS. 1 to 19, a ladder assembly 100 in accordance with the present technology includes a mounting frame 1, a first ladder frame 2, and a second ladder frame 3.

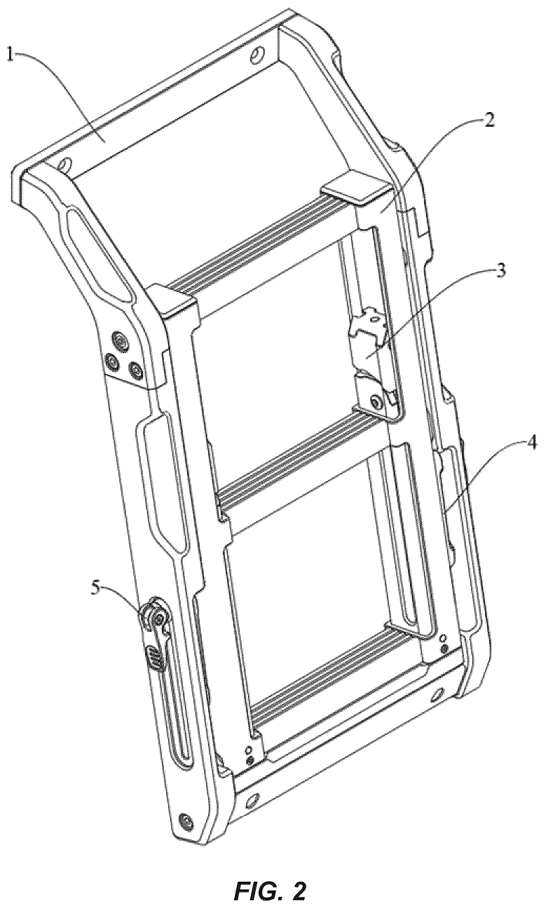

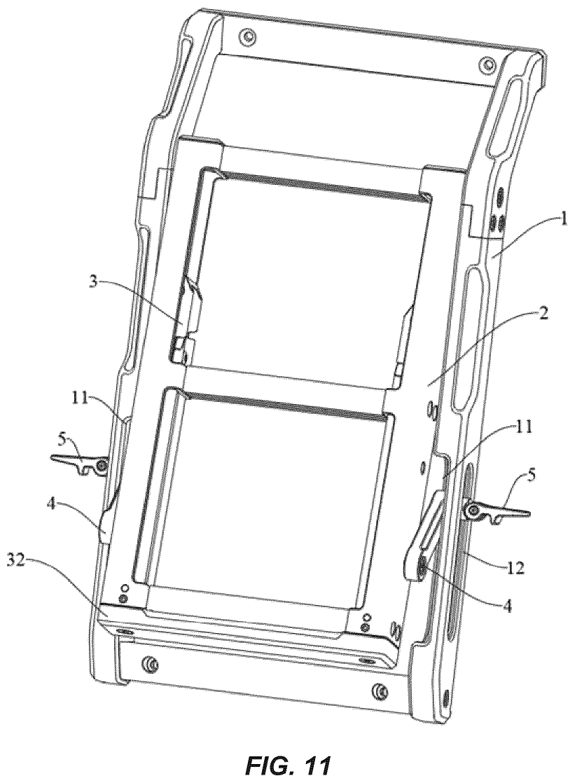

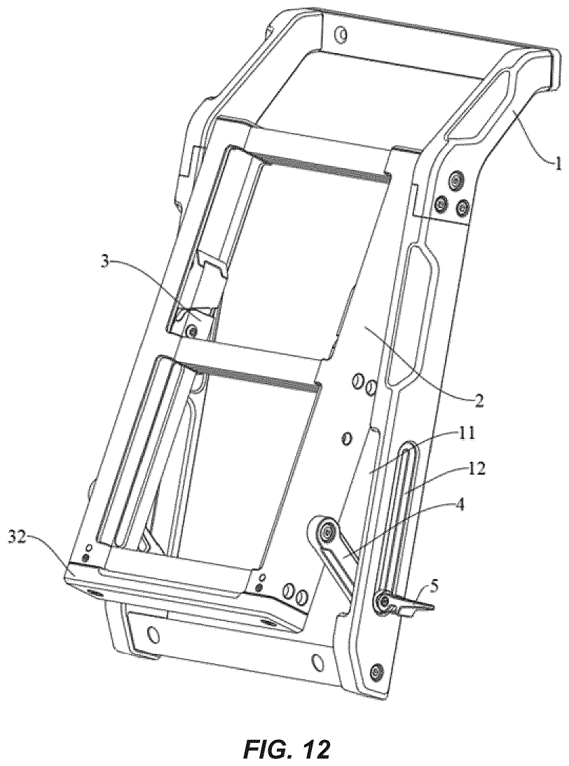

The first ladder frame 2 is pivotally connected to the mounting frame 1, so that the first ladder frame 2 is able to swing between a stowed position and a deployed position relative to the mounting frame 1. For example, FIGS. 1 and 2 show the first ladder frame 2 in the stowed position, while FIGS. 12 to 14, 16, and 17 show the first ladder frame 2 in the deployed position. FIG. 11 illustrates the first ladder frame 2 swinging from the stowed position toward the deployed position.

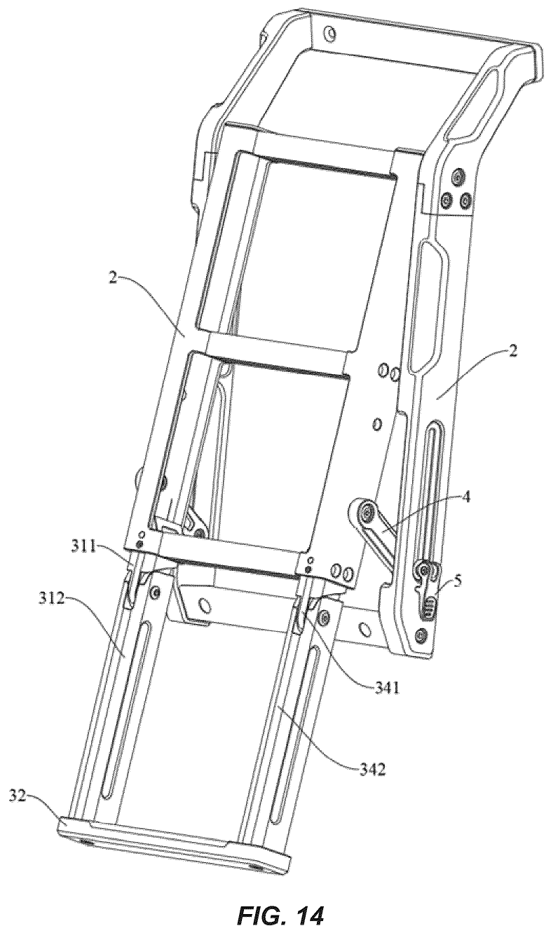

The second ladder frame 3 is slidably connected to the first ladder frame 2, so that the second ladder frame 3 moves between an extended position and a retracted position relative to the first ladder frame 2. For example, FIGS. 1 and 2 and FIGS. 11 to 13 show the second ladder frame 3 in the retracted position, while FIGS. 14, 16, and 17 show the second ladder frame 3 in the extended position.

During use, the user manually pulls the first ladder frame 2 to swing it from the stowed position to the deployed position, and then, the user pulls the second ladder frame 3 to slide the second ladder frame 3 from the retracted position to the extended position. Then, the user can climb up through the ladder assembly 100, for example, to access the vehicle roof.

In the ladder assembly of some embodiments in accordance with the present technology, the first ladder frame is deployed from the mounting frame and stowed into the mounting frame through swinging, while the second ladder frame extends and is retracted through sliding, so that there is no need for the user to flip the second ladder frame, making the operation simple and labor-saving. When in use, the first ladder frame and the mounting frame form an approximate triangular structure, which enhances the structural strength and stability. Additionally, the space required for operations of the swinging of the first ladder frame and the extending/retracting of the second ladder frame is small, and regardless of whether the first ladder frame is in the stowed or deployed position, the ladder assembly occupies a small volume and space, has a compact structure, and is convenient for installation and use.

In some embodiments, in the stowed position, the first ladder frame 2 is overlapped on the mounting frame 1, for example, the first ladder frame 2 is overlapped on top of the mounting frame 1, with the first ladder frame 2 being substantially parallel to the mounting frame 1, that is, a plane of the first ladder frame 2 is substantially parallel to a plane of the mounting frame 1. Optionally, in the stowed position, the first ladder frame 2 is sleeved outside the mounting frame 1, so that the first ladder frame 2 and the mounting frame 1 are in the same plane. Advantageously, in the stowed position, the first ladder frame 2 is located inside the mounting frame 1, so that the first ladder frame 2 and the mounting frame 1 are in a same plane. The mounting frame 1 can protect the first ladder frame 2 from damage, as shown in FIGS. 1 and 2.

In the deployed position, the first ladder frame 2 is deployed from the mounting frame 1, that is, the first ladder frame 2 pivots away from the mounting frame 1, so that the first ladder frame 2 intersects with the mounting frame 1, that is, the plane of the first ladder frame 2 intersects with the plane of the mounting frame 1, as shown in FIGS. 12 to 14, 16, and 17.

It should be understood here that the stowed position refers to an extreme position to which the first ladder frame 2 is able to swing along a direction of approaching the mounting frame 1 and in which the angle α between the first ladder frame 2 and the mounting frame 1 is minimal, which is preferably zero degrees, as shown in FIGS. 1 and 2. The deployed position refers to an extreme position to which the first ladder frame 2 is able to swing away from the mounting frame 1, and in which the angle α between the first ladder frame 2 and the mounting frame 1 is maximal, which is preferably 30 degrees, as shown in FIGS. 12 to 14, 16, and 17.

It can be understood that during the process of swinging from the stowed position toward the deployed position or from the deployed position toward the stowed position, the angle α between the first ladder frame 2 and the mounting frame 1 gradually changes, for example, the angle α gradually increases from zero degrees to 30 degrees, or decreases from 30 degrees to zero degrees. During this process, the position of the first ladder frame 2 can be referred to as the intermediate swinging position, as shown in FIG. 11.

In some embodiments, in the extended position, the second ladder frame 3 slides along the direction away from a connection point between the first ladder frame 2 and the mounting frame 1 to extend beyond the first ladder frame 2 by a first predetermined length, as shown in FIG. 14.

In the retracted position, the second ladder frame 3 does not extend beyond the first ladder frame 2, and optionally, the second ladder frame 3 may extend beyond the first ladder frame 2 by a second predetermined length, which is less than the first predetermined length.

It can be understood that the extended position refers to an extreme position to which the second ladder frame 3 is able to slide in the direction away from the connection point between the first ladder frame 2 and the mounting frame 1; that is, the second ladder frame 3 extending by the maximal first predetermined length, as shown in FIGS. 14, 16, and 17. The retracted position refers to an extreme position to which the second ladder frame 3 is able to slide in the direction toward the connection point between the first ladder frame 2 and the mounting frame 1; that is, the second ladder frame 3 is not extending beyond the first ladder frame 2 or optionally extending by the minimal second predetermined length, as shown in FIGS. 1 and 2 and FIGS. 11 to 13. It can be understood that the position of the second ladder frame 3 between the extended position and the retracted position can be referred to as the intermediate sliding position.

In some embodiments, as shown in FIGS. 1 to 3, 11 to 14, and 16 and 17, the ladder assembly 100 also includes a connecting rod 4 and a locking part 5. The first connecting-rod end 41 of the connecting rod 4 is pivotally connected to the mounting frame 1, for example, through a pivot, and the first connecting-rod end 41 can slide relative to the mounting frame 1. The second connecting-rod end 42 of the connecting rod 4 is pivotally connected to the first ladder frame 2, for example, through a pivot. In the illustrated embodiments, there are two connecting rods 4 and two locking parts 5, located on the left and right sides of the mounting frame 1, respectively.

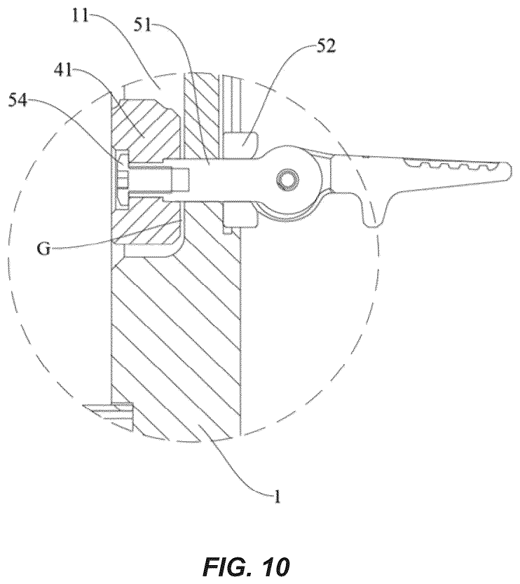

The locking part 5 is slidably mounted on the mounting frame 1 and is connected to the first connecting-rod end 41 of the connecting rod 4. The locking part 5 has a locking state and a releasing state. As shown in FIGS. 1 to 3, 9, 13 and 14, and 16 and 17, in the locking state, the locking part 5 locks the first connecting-rod end 41 by pressing the first connecting-rod end 41 against the mounting frame 1, thereby preventing the first connecting-rod end 41 from sliding along the mounting frame 1, thus preventing the connecting rod 4 from rotating relative to the mounting frame 1 and further preventing the first ladder frame 2 from swinging relative to the mounting frame 1. As shown in FIGS. 10 to 12, in the releasing state, the locking part 5 releases the first connecting-rod end 41, and a gap G is formed between the first connecting-rod end 41 and the mounting frame 1, which allows the first connecting-rod end 41 to slide along the mounting frame 1, thereby allowing the connecting rod 4 to rotate relative to the mounting frame 1 and further allowing the first ladder frame 2 to swing relative to the mounting frame 1.

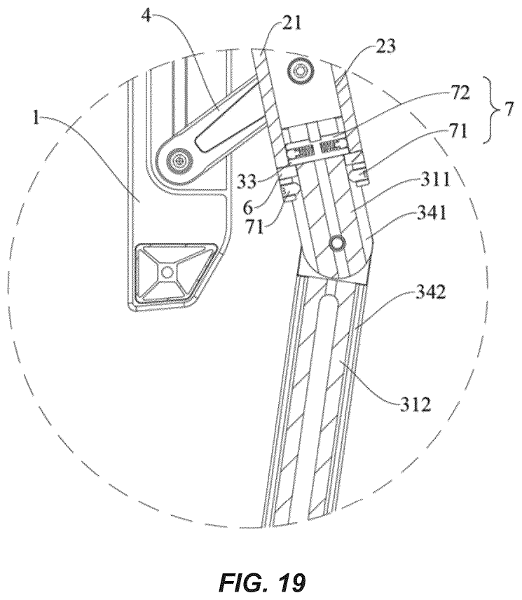

In some embodiments, the ladder assembly 100 includes a stop pin 6 provided on the first ladder frame 2 to stop the second ladder frame 3 and limit an extension length of the second ladder frame 3 relative to the first ladder frame 2, for example, limiting the extended position of the second ladder frame 3, as shown in FIG. 19.

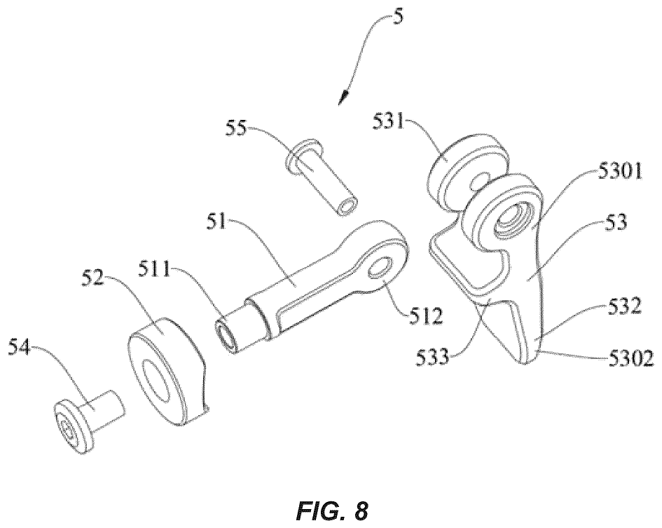

As shown in FIGS. 8 to 10, in some examples, the locking part 5 includes an actuating rod 51, an abutment boss 52, and a handle 53. The handle 53 is used to drive the actuating rod 51. The handle 53 comprises a holding portion 532, a cam portion 531, and a limiting protrusion 533. The holding portion 532 is used for the user to hold so as to operate the handle 53 and has a connecting end 5301 and a free end 5302. The cam portion 531 is arranged at the connecting end 5301 of the holding portion 532, and the limiting protrusion 533 is provided on the holding portion 532. The first connecting end 511 of the actuating rod 51 is connected to the first connecting-rod end 41 through a connecting bolt 54, and the second connecting end 512 of the actuating rod 51 is pivotally connected to the cam portion 531 through a third pivot 55. The cam surface of the cam portion 531 contacts the abutment boss 52. When the handle 53 is rotated, the actuating rod 51 is driven to move along its axial direction to lock and release the connecting rod 4. The limiting protrusion 533 is used to abut against the mounting frame 1 to restrict the rotation of the handle 53. When the locking part 5 is in the locked state, the limiting protrusion 533 abuts against the mounting frame 1.

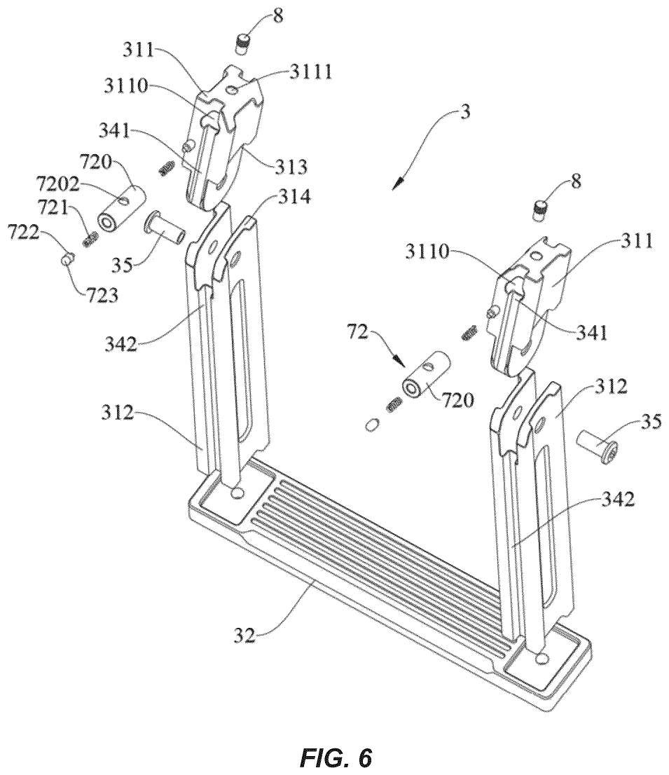

As shown in FIGS. 6, 7A, 7B, and 19, the ladder assembly 100 includes a fastening part 7, and the fastening part 7 is provided on one of the first ladder frame 2 and the second ladder frame 3 and abuts against the other one of the first ladder frame 2 and the second ladder frame 3. The fastening part 7 is used to provide damping for the sliding movement of the second ladder frame 3 relative to the first ladder frame 2, thereby preventing the second ladder frame 3 from accidentally sliding relative to the first ladder frame 2 due to the weight of the second ladder frame 3 and allowing the second ladder frame 3 to slide relative to the first ladder frame 2 under an external pulling force. For example, a user can pull the second ladder frame 3 to overcome the damping force of the fastening part 7 to slide the second ladder frame 3 relative to the first ladder frame 2.

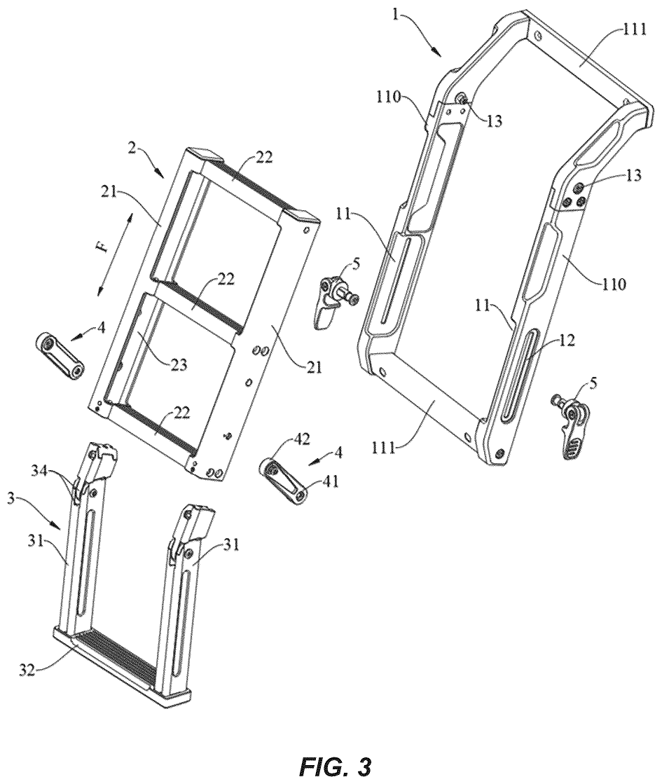

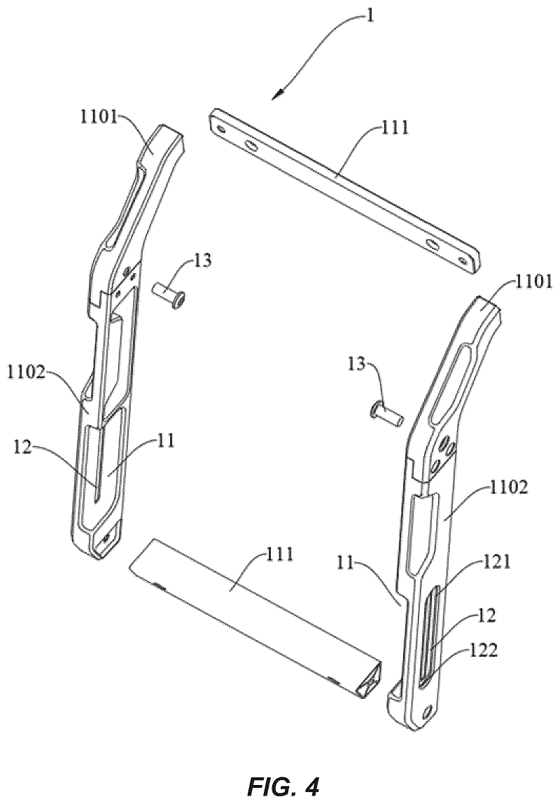

In some embodiments, as shown in FIGS. 3 and 4, the mounting frame 1 is a generally rectangular frame, specifically, the mounting frame 1 includes two side frame beams 110 and two cross frame beams 111. The two side frame beams 110 extend parallel to each other in an up-down direction and are spaced apart. One cross frame beam 111 is removably connected between the upper ends of the two side frame beams 110, and the other cross frame beam 111 is removably connected between the lower ends of the two side frame beams 110. In the embodiment shown in FIG. 4, there are two cross frame beams 111, to which embodiments of the present technology are not limited. For example, three or four cross frame beams 111 may be provided.

As shown in FIG. 4, in some specific examples, each side frame beam 110 includes an upper beam section 1101 and a lower beam section 1102. The upper beam section 1101 and the lower beam section 1102 can be integrally formed or removably connected. As shown in FIG. 1, the lower beam section 1102 extends generally in the vertical direction, and the upper beam section 1101 extends upward and backward obliquely from the upper end of the lower beam section 1102 to facilitate the installation of the mounting frame 1 onto a vehicle. The upper beam section 1101 and the lower beam section 1102 can also extend coaxially, for example, along the longitudinal direction of the mounting frame 1, such as the vertical direction as shown in FIG. 1. It should be understood that when the upper beam section 1101 extends obliquely relative to the lower beam section 1102, the plane in which the mounting frame 1 is located refers to the plane defined by the two lower beam sections 1102. The angle α between the first ladder frame 2 and the mounting frame 1 refers to the angle between the first ladder frame 2 and the plane defined by the two lower beam sections 1102.

As shown in FIG. 4, the lower beam section 1102 of the side frame beam 110 has a guide groove 12 that extends along the longitudinal direction of the lower beam section 1102 and penetrates through the thickness direction of the lower beam section 1102. The guide groove 12 can be straight or curved, preferably straight. The first connecting-rod end 41 of the connecting rod 4 may slide along the guide groove 12. The first connecting end 511 of the actuating rod 51 of the locking part 5 passes through the guide groove 12 and is connected to the first connecting-rod end 41 of the connecting rod 4, and the actuating rod 51 is able to slide along the guide groove 12.

The inner side surface of the lower beam section 1102 has an accommodating groove 11, which provides a clearance space for the rotation of the connecting rod 14, and in the stowed position, the connecting rod 4 is accommodated within the accommodating groove 11, as shown in FIGS. 1 and 2, thereby providing structural compactness of the ladder assembly 100.

In some embodiments, the first end 121 and the second end 122 of the guide groove 12 each have a snap slot. The first connecting-rod end 41 of the connecting rod 4 can slide into and be retained within the snap slot (not shown), thereby preventing the first connecting-rod end 41 from sliding along the guide groove 12. The user can pull the first ladder frame 2 to release the first connecting-rod end 41 from the snap slot and allow the first ladder frame 2 to slide along the guide groove 12. It can be understood that the snap slot can serve the function of the locking part 5. Therefore, the snap slot and the locking part 5 can be selectively provided. The snap slot and the locking part 5 can also be provided simultaneously to enhance the reliability of the locking mechanism.

In some embodiments, the cross-section of the side frame beam 110 can be L-shaped. In the stowed position, the first ladder frame 2 is located between the side frame beams 110 and rests against the inwardly extending portions of the side frame beams 110, so that the side frame beams 110 can act as a housing to protect the first ladder frame 2.

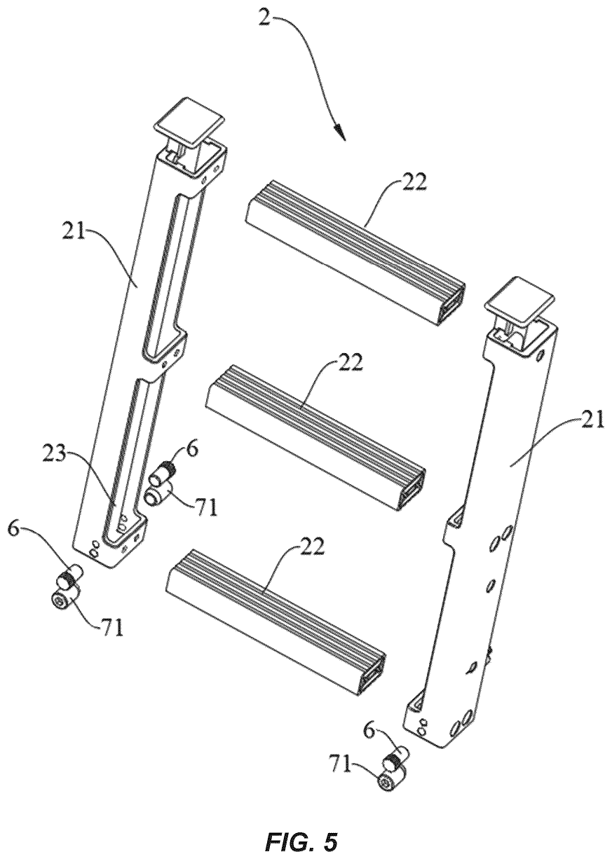

As shown in FIGS. 3 and 5, the first ladder frame 2 is a generally rectangular frame and includes first ladder side beams 21 and first ladder cross beams 22. The two first ladder side beams 21 extend parallel to each other along the longitudinal direction F of the first ladder frame 2 and are spaced apart. The first ladder cross beams 22 are removably connected between the first ladder side beams 21. In the illustrated embodiment, the first ladder frame 2 includes three first ladder cross beams 22, which are respectively connected between the upper ends, lower ends, and midsections of the two first ladder side beams 21. It should be understood that the number of first ladder cross beams 22 is not limited to three.

As shown in FIGS. 1 to 3, the upper end of each first ladder side beam 21 is pivotally connected to the side frame beam 110 via a first pivot 13. More specifically, the first pivot 13 is located at the lower end of the upper beam section 1101 or the upper end of the lower beam section 1102. The first pivot 13 extends inward from the inner surface of the side frame beam 110 to engage with the pivot hole at the upper end of the first ladder side beam 21. The first ladder side beam 21 has a first sliding groove 23 extending along its longitudinal direction F, and the second ladder frame 3 can be accommodated within the first sliding groove 23 and slide along the first sliding groove 23.

Advantageously, in the stowed position, the first ladder frame 2 is located inside the mounting frame 1, in other words, the first ladder side beam 21 is positioned inside the side frame beam 110 and arranged side by side, that is, the plane defined by the longitudinal axes of the two first ladder side beams 21 coincides with the plane defined by the longitudinal axes of the two side frame beams 110, i.e., of the two lower beam sections 1102, thereby further enhancing the structural compactness of the ladder assembly.

Optionally, the first pivot 13 can extend outward from the outer surface of the side frame beam 110 to engage with the pivot hole at the upper end of the first ladder side beam 21. In the stowed position, the first ladder side beam 21 is located outside the side frame beam 110 and arranged side by side.

Optionally, the first pivot 13 can be arranged on the front surface of the side frame beam 110. In the stowed position, the first ladder frame 2 is overlapped on the mounting frame 1.

As shown in FIGS. 3 and 6, the second ladder frame 3 is generally U-shaped and includes the second ladder side beams 31 and the second ladder cross beam 32. The second ladder cross beam 32 is removably connected between the lower ends of the second ladder side beams 31. The second ladder side beams 31 are accommodated within the first sliding groove 23 and can slide along the first sliding groove 23.

In the retracted position, the second ladder side beams 31 are retracted into the first sliding groove 23, and the second ladder cross beam 32 is located outside the first sliding groove 23 and abuts against the lower end of the first ladder side beams 21. In the extended position, the upper end of the second ladder side beams 31 is located within the first sliding groove 23, with the majority of the second ladder side beams 31 extending downward from the first sliding groove 23.

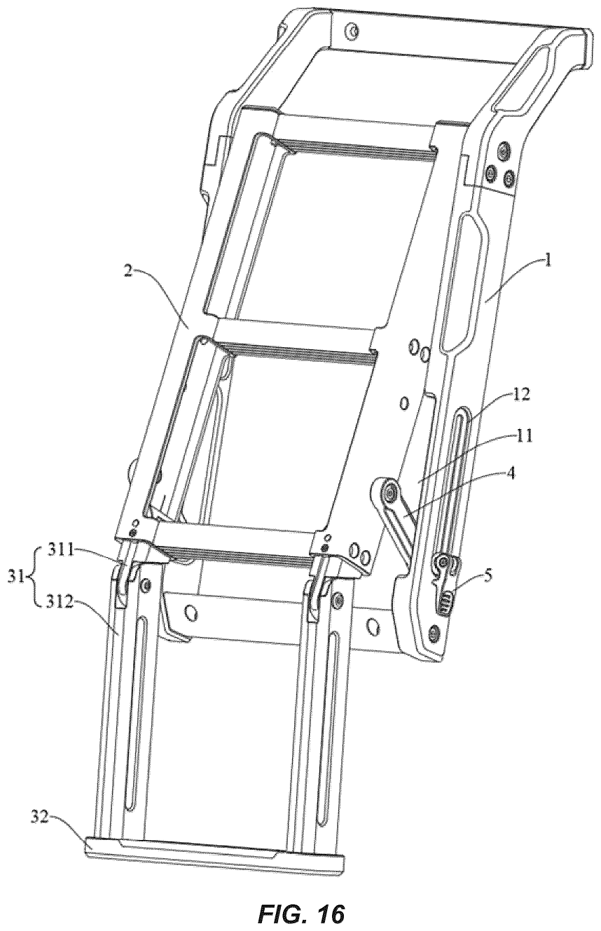

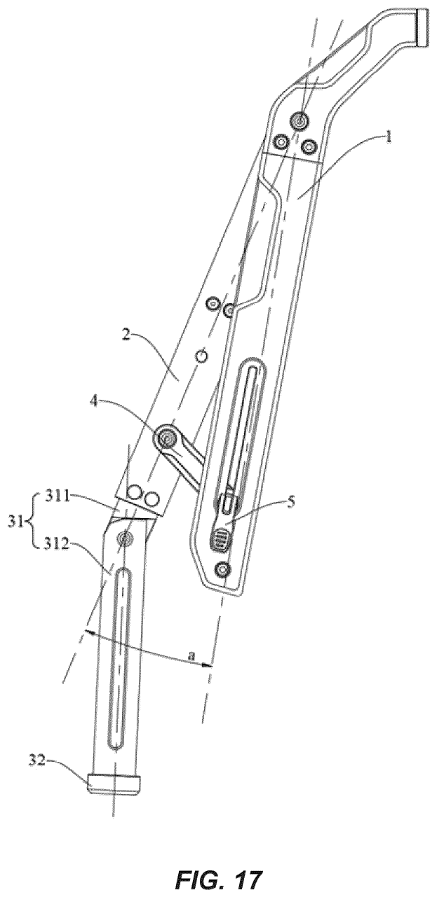

Advantageously, as shown in FIGS. 3, 6, and 14-19, the second ladder side beams 31 include an upper side beam section 311 and a lower side beam section 312. The upper end of the upper side beam section 311 has an accommodating hole 3110, and the lower end of the upper side beam section 311 is pivotally and removably connected to the upper end of the lower side beam section 312 through a second pivot 35. In the extended position, the lower end of the upper side beam section 311 and the lower side beam section 312 slide out of the first sliding groove 23 and the lower side beam section 312 pivots relative to the upper side beam section 311 due to gravity, to extend vertically, that is, the upper side beam section 311 and the lower side beam section 312 create an angle between them, as shown in FIGS. 16 and 17, facilitating the user to climb the ladder assembly.

In the extended position, the lower side beam section 312 has a first state and a second state. In the first state, the upper side beam section 311 is coaxial with the lower side beam section 312. In the second state, the upper side beam section 311 extends vertically and forms an angle with the lower side beam section 312. Therefore, when in the first state, the position of the second ladder frame 3 can be referred to as the initial extended position, and when in the second state, the position of the second ladder frame 3 can be referred to as the final extended position.

As shown in FIG. 19, the upper end of the second ladder side beams 31 has a stop portion 33, and the first ladder side beam 21 has the stop pin 6. The stop pin 6 is used to abut the stop portion 33 to prevent the upper end of the second ladder side beams 31, i.e., the upper end of the upper side beam section 311, from disengaging from the first sliding groove 23, which limits the maximum length of the second ladder side beams 31 extending from the first sliding groove 23, thereby limiting the extended position of the second ladder frame 3.

As shown in FIGS. 3, 6, and 14-19, the second ladder side beams 31 have a second sliding groove 34, and specifically, the second sliding groove 34 includes an upper sliding section 341 formed on the surface of the upper side beam section 311 and a lower sliding section 342 formed on the lower side beam section 312.

As shown in FIGS. 6, 7A, 7B, and 19, the fastening part 7 includes a first fastening part 71 and a second fastening part 72.

Specifically, the first fastening part 71 includes a first fastening base 710 having a first mounting hole 7101, a first elastic piece 711, a first push rod 712, and a first push ball 713.

The first fastening base 710 is installed on the first ladder side beam 21. The inner end of the first push rod 712 is fitted into the first mounting hole 7101, and the outer end of the first push rod 712 has a first accommodating groove 7121. The first push ball 713 is rotatably housed in the first accommodating groove 7121, with a portion of the first push ball 713 protruding from the first accommodating groove 7121.

The first elastic piece 711 is located within the first mounting hole 7101 and is arranged between the first fastening base 710 and the first push rod 712. The first elastic piece 711 presses the first push rod 712 in a direction away from the first fastening base 710, causing the first push ball 713 to abut against the bottom surface of the second sliding groove 34, thereby providing damping for the sliding of the second ladder side beams 31.

Specifically, the second fastening part 72 includes a second fastening base 720, a second elastic piece 721, a second push rod 722, and a second push ball 723. The second fastening base 720 has second mounting holes 7201 at its opposite ends.

The second fastening base 720 is installed at the upper end of the second ladder side beams 31 and is located within the first sliding groove 23. Specifically, the upper end of the upper side beam section 311 has an accommodating hole 3110, and the second fastening base 720 is arranged within the accommodating hole 3110. The second fastening base 720 has a positioning hole 7202, and the upper end surface of the upper side beam section 311 has a through hole 3111 that communicates with the accommodating hole 3110. A positioning pin 8 engages with the through hole 3111 and the positioning hole 7202, thereby positioning the second fastening base 720 within the accommodating hole 3110.

The inner end of the second push rod 722 is fitted into the second mounting hole 7201, and the outer end of the second push rod 722 has a second accommodating groove 7221. The second push ball 723 is rotatably housed in the second accommodating groove 7221, with a portion of the second push ball 723 protruding from the second accommodating groove 7221.

The second elastic piece 721 is located within the second mounting hole 7201 and is arranged between the second fastening base 720 and the second push rod 722. The second elastic piece 721 pushes the second push rod 722 in a direction away from the second fastening base 720, causing the two second push balls 723 to abut against the side surfaces of the first sliding groove 23, thereby providing damping for the sliding of the second ladder side beams 31.

As shown in FIGS. 6 and 19, in the illustrated embodiments, the end of the second fastening base 720 forms the stop portion 33 that is stopped by the stop pin 6.

In some embodiments, as shown in FIGS. 6, 15, and 18, the lower end surface of the upper side beam section 311 has an inclined first abutment surface 313. The upper end surface of the lower side beam section 312 has a second abutment surface 314 that is opposite and complementary to the first abutment surface 313. When the second ladder frame 3 slides to the extended position, the lower side beam section 312 rotates relative to the upper side beam section 311 to extend vertically, and when the lower side beam section 312 reaches the vertically extended position, the second abutment surface 314 abuts against the first abutment surface 313 to prevent further rotation of the lower side beam section 312.

In other embodiments, the ladder assembly 100 includes a mounting frame 1, a first ladder frame 2, a second ladder frame 3, a connecting rod 4, and a locking part 5. The first ladder frame 2 is pivotally connected to the mounting frame 1. The second ladder frame 3 is connected to the first ladder frame 2 in an extendable and retractable manner. The first connecting-rod end 41 of the connecting rod 4 is pivotally connected to the mounting frame 1, and the second connecting-rod end 42 of the connecting rod 4 is pivotally connected to the first ladder frame 2. The locking part 5 is used to lock the first ladder frame 2 to prevent the first ladder frame 2 from swinging relative to the mounting frame 1 and to release the first ladder frame 2 to allow the first ladder frame 2 to swing relative to the mounting frame 1.

The ladder assembly 100 can move between a stowed state, a deployed state, and an extended state.

In the stowed state, the first ladder frame 2 swings into the mounting frame 1 and is arranged side by side with the mounting frame 1, and the second ladder frame 3 is retracted relative to the first ladder frame 2. In other words, when the first ladder frame 2 is in the stowed position, advantageously, the first ladder side beams 21 are located inside the lower beam section 1102 of the side frame beams 110 and arranged side by side. In this state, the second ladder frame 3 is in the retracted position, the second ladder side beams 31 are retracted into the first sliding groove 23, and the second ladder cross beam 32 abuts against the lower end of the second ladder side beams 31 and located above the cross frame beam 111.

In the deployed state, the first ladder frame 2 swings out from the mounting frame 1 to the deployed position, and the first ladder frame 2 forms a predetermined angle α with the mounting frame 1. In the deployed state, the second ladder frame 3 can be in either the retracted position or the extended position.

In the extended state, the first ladder frame 2 swings out from the mounting frame 1 to the deployed position, and the first ladder frame 2 forms a predetermined angle α with the mounting frame 1. The second ladder side beams 31 extend out from the first sliding groove 23, while the upper end of the upper side beam section 311 is located within the first sliding groove 23. In the extended state, the lower side beam section 312 can be in either the first state or the second state. In the first state, the lower side beam section 312 is coaxial with the upper side beam section 311. In the second state, the lower side beam section 312 extends in the vertical direction and forms a predetermined angle with the upper side beam section 311. When the lower side beam section 312 is in the first state, the state of the ladder assembly 100 can be referred to as the initial extended state. When the lower side beam section 312 is in the second state, the state of the ladder assembly 100 can be referred to as the final extended state.

Operation and functioning of the ladder assembly 100 of embodiments in accordance with the present technology are described below.

As shown in FIGS. 1 and 2, when not in use, the ladder assembly 100 is in the stowed state, with the first ladder frame 2 located inside the mounting frame 1 and the second ladder frame 3 retracted into the first sliding groove 23 of the first ladder frame 2. The locking part 5 is in the locked state to prevent the first ladder frame 2 from accidentally swinging relative to the mounting frame 1.

As shown in FIG. 11, when using the ladder assembly 100, the holding portion 532 is rotated upward to release the connecting rod 4 from the locking part 5. The user pulls the first ladder frame 2 forward to swing it out from the mounting frame 1. During the swinging-out process, the first connecting-rod end 41 of the connecting rod 4 and the locking part 5 slide downward together along the guide groove 12, and the connecting rod 4 rotates relative to the mounting frame 1 and the first ladder frame 2, as shown in FIG. 12.

After the first ladder frame 2 reaches the swinging-out position, for example, when the first connecting-rod end 41 of the connecting rod 4 reaches the lower end of the guide groove 12, the holding portion 532 is rotated downward to lock the connecting rod 4 and prevent the first ladder frame 2 from swinging, that is, to secure the first ladder frame 2 in the deployed position. At this point, due to the damping effect of the fastening part 7, the second ladder frame 3 will not slide toward the extended position relative to the first ladder frame 2 without an external force.

If the length of the first ladder frame 2 meets the requirement, there is no need to slide the second ladder frame 3 to the extended position to climb the ladder assembly 100.

If the length of the first ladder frame 2 does not meet the requirement, the user may overcome the damping of the fastening part 7 to pull the second ladder frame 3 to slide toward the extended position from the first sliding groove 23, as shown in FIG. 14. The user then releases the second ladder frame 3, and the lower side beam section 312 of the second ladder side beams 31 rotates downward to a vertical state due to its own weight relative to the upper side beam section 311, that is, the lower side beam section 312 extends along a vertical direction, as shown in FIGS. 16 and 17, and then, the user may climb the ladder assembly 100.

After use, the user first rotates the lower side beam section 312 of the second ladder side beams 31 from the vertical state to a coaxial state with the upper side beam section 311, then overcomes the damping of the fastening part 7 to push the second ladder side beams 31 into the first sliding groove 23. Next, the user operates the locking part 5 to a release state and pushes the first ladder frame 2 backward to the stowed position. Finally, the user operates the locking part 5 to a locked state to lock the first ladder frame 2 relative to the mounting frame 1.

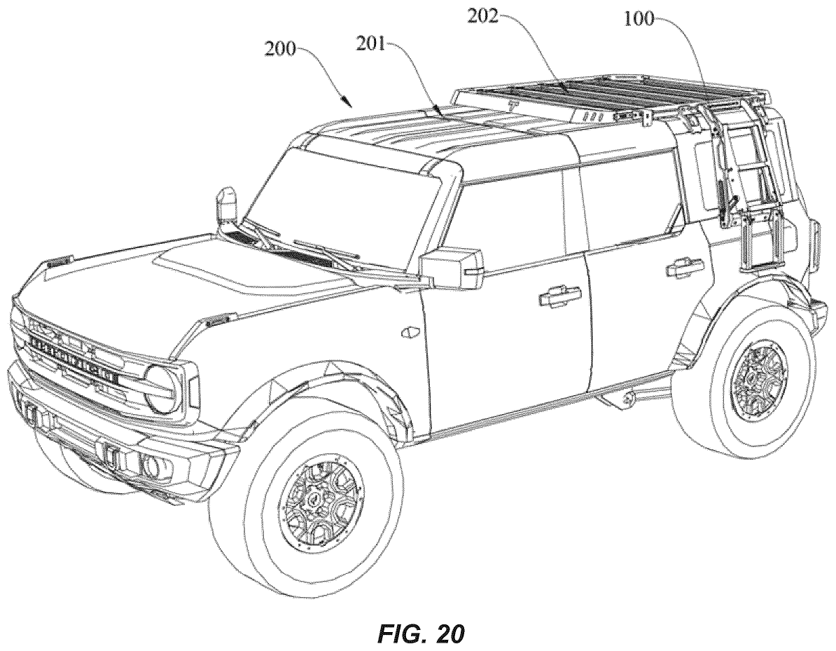

Below is the description of the vehicle according to embodiments of the present technology. As shown in FIG. 20, the vehicle 200 according to embodiments of the present technology includes a vehicle body 201 and a ladder assembly, which can be the aforementioned ladder assembly 100. The ladder assembly 100 is installed on the vehicle body 201.

Specifically, as shown in FIG. 20, the vehicle body 201 has a roof rack 202, which is located on the top of the vehicle body 201. The ladder assembly 100 is mounted on the side of the vehicle body 201 and is connected to the roof rack 202. The lower beam section 1102 of the mounting frame 1 is positioned on the side of the vehicle body 201, while the upper beam section 1101 extends upward obliquely from the side of the vehicle body 201 and connects with the roof rack 202.

Users can access the top of the vehicle 200 by climbing the ladder assembly 100. The ladder assembly 100 is compact in structure, requires minimal space for operation, and reduces aerodynamic drag.

It should be understood that the ladder assembly is not limited to being installed on the side of the vehicle body. Optionally, the ladder assembly can be installed on the rear of the vehicle body. Moreover, the ladder assembly is not limited to use on vehicles and can also be used in other suitable applications.

The technical features illustrated in the above specific examples can be implemented in various configurations. Some examples of such configurations are provided below.

In some example embodiments, a ladder assembly includes a mounting frame 1; a first ladder frame 2 pivotally connected with the mounting frame 1 and configured to swing into or out from the mounting frame 1; and a second ladder frame 3 including a first portion and a second portion, wherein a lower end of the first portion is pivotally connected with an upper end of the second portion; the second ladder frame 3 is slidably connected with the first ladder frame 2; and the second ladder frame 3 is extendable relative to the first ladder frame 2 so that the lower end of the first portion and the second portion extend beyond the first ladder frame 2 and the second portion is oriented in a vertical direction, and the second ladder frame 3 is retractable relative to the first ladder frame 2 so that a lower end of the second portion abuts against a lower end of the first ladder frame 2.

### Conclusion

In the present disclosure, it should be understood that the orientation or positional relationship indicated by the terms “center,” “longitudinal,” “transverse,” “up,” “down,” “front,” “rear,” “left,” “right,” “vertical,” “horizontal,” “top,” “bottom,” “inside,” “outside,” “clockwise,” “counterclockwise,” “axial,” “radial,” “circumferential,” and the like is based on the orientation or positional relationship shown in the attached drawings, which is only for the convenience of describing the present technology and simplifying the description, and does not indicate or imply that the referred device or element must have a specific orientation, and be constructed and operated in a specific orientation, so it cannot be understood as a limitation of the present technology.

In addition, the terms “first” and “second” are only used for purpose of description, and cannot be understood as indicating or implying relative importance or implicitly indicating the number of indicated technical features. Therefore, the feature defined as “first” or “second” may explicitly or implicitly include at least one such feature. In the present disclosure, “a plurality of” means at least two, such as two, three, etc., unless otherwise specifically defined.

In the present disclosure, unless otherwise expressly defined, terms such as “install,” “interconnect,” “connect,” and “fix” shall be understood broadly, and may be, for example, fixed connections, detachable connections, or integral connections; may also be mechanical or electrical connections or intercommunication; may also be direct connections or indirect connections via intervening media; and may also be inner communications or interactions of two elements, unless otherwise specified. For those skilled in the art, the specific meanings of the above terms in the present disclosure can be understood in specific situations.

In the present disclosure, unless otherwise expressly defined and specified, a structure in which a first feature is “on” or “below” a second feature may include an embodiment in which the first feature is in direct contact with the second feature, or may further include an embodiment in which the first feature and the second feature are in indirect contact through intermediate media. Furthermore, a first feature “on,” “above,” or “on top of” a second feature may include an embodiment in which the first feature is right or obliquely “on,” “above,” or “on top of” the second feature, or just means that the first feature is at a height higher than that of the second feature, while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the present disclosure, terms such as “an embodiment,” “some embodiments,” “an example,” “a specific example,” or “some examples” mean that a particular feature, structure, material, or characteristic described in connection with the embodiment or example is included in at least one embodiment or example of the present technology. Thus, the appearances of these terms in various places throughout this specification are not necessarily referring to the same embodiment or example of the present technology. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification.

Although embodiments of the present technology have been shown and described above, it can be understood that the above embodiments are illustrative and shall not be understood as limitation to the present technology, and changes, modifications, alternatives, and variations can be made in the above embodiments within the scope of the present technology by those skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer-readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements, and variations can be made based on what is described and illustrated in this patent document.

What is claimed is:

1. A ladder assembly, comprising:
a mounting frame;
a first ladder frame pivotally connected with the mounting frame, so that the first ladder frame is configured to swing between a stowed position and a deployed position relative to the mounting frame; and
a second ladder frame slidably connected with the first ladder frame, so that the second ladder frame is configured to move between an extended position and a retracted position relative to the first ladder frame.

2. The ladder assembly according to claim 1, wherein
in the stowed position, the first ladder frame and the mounting frame are overlapped with each other, and the first ladder frame is located in the mounting frame, or the first ladder frame is sleeved outside the mounting frame; and
in the deployed position, the first ladder frame is unfolded from the mounting frame so that a plane where the first ladder frame is located intersects with a plane where the mounting frame is located.

3. The ladder assembly according to claim 1, wherein
in the extended position, the second ladder frame extends beyond the first ladder frame by a first predetermined length, and
in the retracted position, the second ladder frame does not extend beyond the first ladder frame or extends beyond the first ladder frame by a second predetermined length, wherein the second predetermined length is smaller than the first predetermined length.

4. The ladder assembly according to claim 1, wherein the first ladder frame is directly and pivotally connected with the mounting frame through a first pivot.

5. The ladder assembly according to claim 4, wherein the first pivot protrudes inward from an inner side surface of the mounting frame, and wherein, in the stowed position,
the first ladder frame is located in the mounting frame so that a plane where the first ladder frame is located coincides with a plane where the mounting frame is located; or
the first pivot protrudes outward from an outer surface of the mounting frame, wherein in the stowed position, the first ladder frame is sleeved outside the mounting frame so that the plane where the first ladder frame is located coincides with the plane where the mounting frame is located; or
the first pivot is arranged on a front surface of the mounting frame, wherein in the stowed position, the first ladder is overlapped on the mounting frame.

6. The ladder assembly according to claim 1, wherein the ladder assembly further comprises a connecting rod, wherein a first connecting-rod end of the connecting rod is pivotally connected with the mounting frame and is configured to slide relative to the mounting frame, and wherein a second connecting-rod end of the connecting rod is pivotally connected with the first ladder frame.

7. The ladder assembly according to claim 6, wherein the mounting frame has a guide groove, the first connecting-rod end is configured to slide along the guide groove, and an inner side surface of the mounting frame has an accommodating groove, and wherein, in the stowed position, the connecting rod is accommodated in the accommodating groove.

8. The ladder assembly according to claim 7, wherein a first end and a second end of the guide groove each have a snap slot, and wherein the first connecting-rod end is configured to slide into the snap slot to prevent the first connecting-rod end from sliding along the guide groove.

9. The ladder assembly according to claim 7, wherein the ladder assembly further comprises a locking part having a locked state and a released state, and wherein the locking part is mounted on the mounting frame slidably along the guide groove and is connected with the first connecting-rod end, wherein, in the locked state, the locking part presses the connecting rod onto the mounting frame to prevent the first connecting-rod end from sliding along the guide groove, so as to prevent the connecting rod from rotating relative to the mounting frame, and wherein, in the released state, the locking part releases the connecting rod to allow the first connecting-rod end to slide along the guide groove, so as to allow the connecting rod to rotate relative to the mounting frame.

10. The ladder assembly according to claim 9, wherein the locking part comprises an actuating rod, an abutment boss and a handle for driving the actuating rod, the handle comprises a holding portion, a cam portion and a limiting protrusion, the holding portion has a connecting end and a free end, the cam portion is arranged at the connecting end of the holding portion, the limiting protrusion is arranged on the holding portion, a first connecting end of the actuating rod is connected with the first connecting-rod end, a second connecting end of the actuating rod is pivotally connected with the cam portion, and a cam surface of the cam portion abuts against the abutment boss, so as to drive the actuating rod to lock or release the connecting rod when the handle rotates, and the limiting protrusion is configured to abut against the mounting frame.

11. The ladder assembly according to claim 6, wherein the ladder assembly further comprises a stop pin, and the stop pin is arranged on the first ladder frame and configured to stop the second ladder frame to limit an extension length of the second ladder frame relative to the first ladder frame.

12. The ladder assembly according to claim 1, wherein
the first ladder frame comprises first ladder side beams and a first ladder cross beam, the first ladder side beams are arranged at intervals in parallel with each other, the first ladder cross beam is connected between the first ladder side beams, and each first ladder side beam has a first sliding groove extending along a longitudinal direction of the first ladder side beam;
the second ladder frame comprises second ladder side beams and a second ladder cross beam, the second ladder cross beam is connected between lower ends of the second ladder side beams, and each second ladder side beam is configured to slide along the first sliding groove, wherein in the retracted position, each second ladder side beam is retracted into the first sliding groove, and the second ladder cross beam is located outside the first sliding groove and abuts against a lower end of each first ladder side beam; and
an upper end of each second ladder side beam has a stop portion, and each first ladder side beam has a stop pin for stopping the stop portion to prevent the upper end of each second ladder side beam from escaping from the first sliding groove.

13. The ladder assembly according to claim 12, wherein the ladder assembly further comprises a fastening part arranged on one of each first ladder side beam and each second ladder side beam and abuts against the other one of each first ladder side beam and each second ladder side beam to damp a sliding of the second ladder frame relative to the first ladder frame, so as to prevent the second ladder frame from sliding under its own gravity relative to the first ladder frame and allow the second ladder frame to slide relative to the first ladder frame by an external force.

14. The ladder assembly according to claim 13, wherein
the fastening part comprises a first fastening part and a second fastening part, and each second ladder side beam has a second sliding groove;
the first fastening part comprises a first fastening base having a first mounting hole, a first elastic piece, a first push rod and a first push ball, the first fastening base is mounted on each first ladder side beam, an inner end of the first push rod is fitted in the first mounting hole, an outer end of the first push rod has a first accommodating groove, the first push ball is rotatably accommodated in the first accommodating groove, a part of the first push ball protrudes from the first accommodating groove, the first elastic piece is located in the first mounting hole and arranged between the first fastening base and the first push rod, and the first elastic piece pushes the first push rod in a direction running away from the first fastening base so that the first push ball abuts against a bottom surface of the second sliding groove; and
the second fastening part comprises a second fastening base, a second elastic piece, a second push rod and a second push ball, two opposite ends of the second fastening base each have a second mounting hole, the second fastening base is mounted at the upper end of each second ladder side beam, an inner end of the second push rod is fitted in the second mounting hole, an outer end of the second push rod has a second accommodating groove, and the second push ball is rotatably accommodated in the second accommodating groove, a part of the second push ball protrudes from the second accommodating groove, the second elastic piece is located in the second mounting hole and arranged between the second fastening base and the second push rod, and the second elastic piece pushes the second push rod in a direction running away from the second fastening base so that the second push ball abuts against a side surface of the first sliding groove.

15. The ladder assembly according to claim 12, wherein each second ladder side beam comprises an upper side beam section and a lower side beam section, and a lower end of the upper side beam section is pivotally connected with an upper end of the lower side beam section, wherein in the extended position, the lower side beam section and the lower end of the upper side beam section disengages from the first sliding groove, and the lower side beam section pivots relative to the upper side beam section by gravity so that the lower side beam section extends in an vertical direction.

16. The ladder assembly according to claim 12, wherein
the mounting frame comprises side frame beams and a cross frame beam, wherein the side frame beams are arranged at intervals in parallel with each other, and the cross frame beam is connected between the side frame beams; and in the stowed position, each first ladder side beam is located on an inner side of a corresponding side frame beam and arranged side by side with the corresponding side frame beam, an inner side surface of each side frame beam has an accommodating groove, and each side frame beam has a guide groove;
the ladder assembly further comprises a connecting rod and a locking part, wherein a first connecting-rod end of the connecting rod is connected with each side frame beam, and a second connecting-rod end of the connecting rod is pivotally connected with the first ladder frame; and
in the stowed position, the connecting rod is accommodated in the accommodating groove; and
the locking part is mounted on the mounting frame slidably along the guide groove and connected with the first connecting-rod end, and the locking part is configured to press the connecting rod onto each side frame beam to prevent the first connecting-rod end from sliding and to release the connecting rod from each side frame beam to allow the first connecting-rod end to slide.

17. A vehicle, comprising:
a vehicle body; and
the ladder assembly according to claim 1, the ladder assembly being mounted on the vehicle body.

18. A ladder assembly, comprising:
a mounting frame;
a first ladder frame pivotally connected with the mounting frame;
a second ladder frame extendably and retractably connected with the first ladder frame;
a connecting rod having a first connecting-rod end pivotally connected with the mounting frame, and a second connecting-rod end pivotally connected with the first ladder frame; and
a locking part for locking the first ladder frame to prevent the first ladder frame from swinging relative to the mounting frame or for releasing the first ladder frame to allow the first ladder frame to swing relative to the mounting frame,
wherein the ladder assembly is configured to move between the following states:
a stowed state, in which the first ladder frame swings into the mounting frame and is arranged side by side with the mounting frame, and the second ladder frame is retracted relative to the first ladder frame;
a deployed state, in which the first ladder frame swings out from the mounting frame and forms a predetermined included angle with the mounting frame; and
an extended state, in which the first ladder frame swings out from the mounting frame to form a predetermined included angle with the mounting frame, and the second ladder frame extends out relative to the first ladder frame.

19. A ladder assembly, comprising:
a mounting frame comprising side frame beams and a cross frame beam, wherein the side frame beams are arranged at intervals in parallel with each other, the cross frame beam is connected between the side frame beams, each side frame beam has a guide groove extending along a longitudinal direction of the side frame beam, and an inner side surface of each side frame beam has an accommodating groove;
a first ladder frame comprising first ladder side beams and a first ladder cross beam, wherein the first ladder side beams are arranged at intervals in parallel with each other, the first ladder cross beam is connected between the first ladder side beams; and each first ladder side beam has a first sliding groove extending along a longitudinal direction of the first ladder side beam; an upper end of each first ladder side beam is pivotally connected with a corresponding side frame beam, the first ladder frame is configured to swing into the mounting frame so that each first ladder side beam is arranged side by side with the corresponding side frame beam and located on an inner side of the corresponding side frame beam, and the first ladder frame is configured to swing out from the mounting frame so that each first ladder side beam intersects with the corresponding side frame beam;
a second ladder frame comprising second ladder side beams and a second ladder cross beam, wherein each second ladder side beam comprises an upper side beam section and a lower side beam section, a lower end of the upper side beam section is pivotally connected with an upper end of the lower side beam section, the second ladder cross beam is connected between the lower ends of the lower side beam sections, each second ladder side beam is slidably arranged in a corresponding first sliding groove, the second ladder cross beam is configured to be retracted into the corresponding first sliding groove, and the second ladder cross beam is located outside the first sliding groove to abut against a lower end of the first ladder frame, and each second ladder side beam is configured to extend out from the corresponding first sliding groove so that the lower end of the upper side beam section and the lower side beam section are located outside the first sliding groove and the lower side beam section rotates relative to the upper side beam section to extend in a vertical direction;
a connecting rod having a first connecting-rod end pivotally connected with each side frame beam and configured to slide along the guide groove, and a second connecting-rod end pivotally connected with the first ladder side beam; and
a locking part configured to releasably lock the connecting rod to prevent or allow the first connecting-rod end to slide along the guide groove, so as to prevent or allow the first ladder frame to swing relative to the mounting frame.
